(19) United States
(12) Patent Application Publication
(10) Pub. No.: US 2010/0324831 A1
(43) Pub. Date: Dec. 23, 2010

(54) Dating Art Objects

(75) Inventors: Elena Basner, St. Petersburg (RU); Sergey Felitsyn, St. Petersburg (RU); Andrey Krusanov, St. Petersburg (RU)

Correspondence Address: POTOMAC PATENT GROUP PLLC, P. O. BOX 270, FREDERICKSBURG, VA, 22404, US

(73) Assignee: Elena Basner, St. Petersburg (RU)

(21) Appl. No.: 12/521,677

(22) PCT Filed: Jan. 30, 2007
(86) PCT No.: PCT/IB2007/000221

§ 371 Date: Sep. 11, 2009

(51) Int. Cl. G01N 31/00

(52) U.S. Cl. 702/23; 250/281

(57) ABSTRACT

In a method of dating paintings in particular from the last two hundred years isotopes of a selected element are detected which are found in living plants and used for making binding agents of artistic paint. In the detection only the relative concentration of the two isotopes in relation to each other has to be determined. One of them can be radioactive suitably having a half-life period smaller than e.g. 1000 years. For accurate determining even isotopes having shorter half-life periods can be used. For dating paintings alleged to have been made in the 20th century e.g. ⁹⁰Sr and ⁸⁶Sr or ¹³⁷Cs and ¹³³Cs can be used to decide whether a painting was made before or after the midst of said century.

### TECHNICAL FIELD

The present invention is related to determining the date when artistic paintings were made, in particular paintings from the last two hundred years.

### BACKGROUND

Falsification of the objects of art increases ever more.

For example, in the sphere of Russian painting, particularly, Russian Avant-garde art, the most tremendous wave of forgeries appeared in the second half of the 20th century when Russian art of the turn of the centuries obtained a worldwide fame. The level of the falsification increases with an each next exhibition of a prominent Russian artist. The more this art becomes known and studied, the more interest it provokes among collectors, and immediately more false paintings appear in the field of art market.

Methods of natural science and technology were and still are those mostly used for demonstrating falsifications as well as to prove the authenticity of an object of art, but on the other hand, every technological report published even in the special literature becomes a kind of schooling for forgery-makers. “Maleviches” which appeared after a numerous exhibitions of the works of the artist in Russia and in the Western countries, and especially after publication of a fundamental book on the base of the collection of Malevich at the State Russian museum, with a thorough technological report, differ greatly from the first, rather naïve, examples of imitation of Malevich's art.

Traditional technological studies—such as chemical analysis of pigments, X-ray and IR analysis, gas-chromatography—still remain the only methods to disclose the falsification. But there exist many serious difficulties in using these methods. Most of the existing methods are based on the principle of revealing the so-called “dating pigments”, i.e. the pigments that appeared at a certain historical period and could not be used earlier—for example, titanium whites, used in painting starting from the late 1920ies, or red cadmium which was not used before 1910. But these facts are widely known, and a “qualified” forgery-maker will never use these “dangerous” components.

The method based on gas-chromatography shows the level of oxidized oil, in particular the proportion of azelaic acid to palmitinic acid, which gives an idea of the age of a studied oil painting. However, it is a fact that the process of oxidation is just the same when a painting has artificially been “aged”, i.e. in unnatural way, and the results of the natural aging and accelerated aging, produced by special treatments, cannot be distinguished for sure.

A main disadvantage of all existing traditional technological methods may be that they are rather subjective, personal, as well as in a case of an expert's judgment, since the results of technological studies are handled according to the particular attitude of the technologist.

### SUMMARY

It is an object of the invention to provide an efficient and/or objective method of dating paintings.

The above mentioned and other problems are efficiently overcome using the present invention.

In a method of proving authenticity of paintings basically concentrations of special isotopes are determined and analyzed.

The selection of suitable isotopes may be based on the fact that in the second half of the 20th century, after tests and use of nuclear explosions had been carried out, principally new technogenic isotopes appeared in nature, in particular in living organisms. Analysis of such isotopes may reveal whether the paint of an art object has been manufactured before or after 1945.

Also, natural isotopes may be used for dating art objects, such as for a making a more or less “absolute dating”.

Generally thus, a radioactive isotope may be used that has a half-life period smaller than 1000 years, in particular a half-life period smaller than 200 years or for dating of recently made paintings even smaller than e.g. 100 years. The half-life period may e.g. be adapted to or be in the range of the length of the time period from the date or year when the art object is alleged or supposed to have been made to the date or year when the dating is made. In particular the half-life period can be e.g. larger than 25% of said time period and/or e.g. smaller than 400% of said time period. It is obvious that the half-life period should not be too small and that it should be selected so that there is a measurable quantity or concentration thereof remaining after said time period.

Usually two isotopes can be used, one of which is selected to be radioactive and the other one is substantially stable, i.e. having a half-life period substantially larger than e.g. 1000 years.

The advantage of the method is not only its objectivity, but also the ease of use: it is enough to take just a small sample of the paint of a studied work of art, avoiding the places of supposed restoration, of course.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments.

### DETAILED DESCRIPTION

A method of dating paintings in particular from the last few hundred years will now be described, the method including that isotopes of a selected element are detected. In particular the isotopes may exist in living plants and used for making binding agents of artistic paint.

As a result of the tests and use of nuclear explosions that have been carried out from the 1940ies, in particular in the second half of the 20^{th} century, the nuclear transmutation of the uranium-actinium series has generated new isotopes which had not existed earlier in nature. Some of these technogenic isotopes such as ¹⁴C and ⁹⁵Zr have either quite a short half-life period, e.g. 64 days for ⁹⁵Zr, or can also arise as a result of natural processes which is true for e.g. ¹⁴C. Thus, they cannot be used for the decision of the question of consideration. However, ¹³⁷Cs and ⁹⁰Sr have half-life periods of about 25 to 37 years, according to the different sources and hence are suitable. The nuclear experiments carried out during 1950-1963 led to admission of considerable amounts of ¹³⁷Cs and ⁹⁰Sr to ecological systems of the Northern hemisphere with atmospheric precipitation. The concentrations of caesium and strontium in the continental natural waters are 2·10⁻⁵ and 7·10⁻² mcg/g, respectively, see Y-H. Li, “A brief discussion on the mean oceanic residence time elements”, GSA, Vol. 46, 1982, pp. 2671-2677, and these caesium and strontium concentrations in turn contain 0.1-0.01% of the isotopes ¹³⁷Cs and ⁹⁰Sr. The accidents at nuclear reactor plants have also later caused an increase of ¹³⁷Cs and ⁹⁰Sr in the surroundings.

Plants of crown flax, Linum usitatissimum, used for the producing linseed oil are mostly located in the Northern hemisphere, and thus the occurrence of the isotopes ¹³⁷Cs and ⁹⁰Sr within the tissue of crown flax that was grown in the second half of the 20^{th} century is quite obvious. Caesium and strontium are not main elements necessary for the growth of plants. But the presence of oxygenic and hydroxylic groups within the aliphatic strands of the carboxylic non-saturated fatty acids makes the unselective adjoining of the cations, i.e. positive ions, of strontium and caesium possible. It can be reminded that the maximum allowable concentration of ¹³⁷Cs and ⁹⁰Sr in food vegetable oil is determined by the authorities and e.g. in the normative documents of the Russian Federation it is within the range of 60-100 Bq/kg. Thus, the isotopes ¹³⁷Cs and ⁹⁰Sr exist specifically in fatty acids of vegetable oils produced from plants that have been growing during the second half of the 20^{th} century.

Hence, in paintings having linseed oil, or any other type of vegetable oil or oils, as a binding substance for the dyestuff or colouring substance the presence or absence of the isotopes ¹³⁷Cs and ⁹⁰Sr can be determined. The presence of ¹³⁷Cs and ⁹⁰Sr in a paint sample determines whether the examined paint was or was not produced in the second half of the 20^{th} century, since the technology of production of oil paints, both in the industrial area and the area of home manufacturing, demands that rather fresh oils are used, and since ¹³⁷Cs and ⁹⁰Sr appeared in living plants only after the nuclear tests and accidents in nuclear power plants had occurred.

For determining the presence of ¹³⁷Cs and ⁹⁰Sr in a paint sample a mass-spectrometric standard method can suitably be used, since the weight of samples should be as small as possible, typically 2-5 mg, and the investigation does not require any information concerning radio-activity or the absolute concentrations of ¹³⁷Cs and ⁹⁰Sr. For the analysis it is sufficient to determine the relative concentrations of the isotopes of interest, i.e. the weight of the isotope in relation to the weight of the normal form of the element. At least one of the parameters (⁹⁰Sr/⁸⁶Sr) and (¹³⁷Cs/¹³³Cs) should thus be determined. In artistic paint produced after the midst of the 20^{th} century that contains polymerized linseed oil, these parameters are greater than 0.0001. In artistic paint produced before the midst of the 20^{th} century, the relation (¹³⁷Cs/¹³³Cs)<0.000001 is valid. Taking into consideration that ¹³⁷Cs is much more widespread than ⁹⁰Sr in the ecosystems of today, in one order of magnitude, in particular ¹³⁷Cs can be used as an indicator for comparative dating of paintings.

In an example, in which samples from paintings having paint in which linseed oil is the binding substance were used, the surface layer of the samples having weights ranging from 2.4 to 6.9 mg were cleansed with 3D HCl, after a preliminary cleansing with ethanol, and then dissolved in a mixture of fluorhydric, perchloric and azotic acids in a water bath. The discharge of caesium and strontium was produced according to the standard methods of two-stage ion-exchange and extraction-chromatographic separation. Mass-spectrometric measuring was made using the spectrometer model Finnigan MAT-261, Triton. In the samples from the paintings dated in 1980s, the concentration (¹³⁷Cs/¹³³Cs) is the range of 0.000139 to 0.001500, whereas in samples of paintings dated in the 1910ths-1930ies the concentration (¹³⁷Cs/¹³³Cs) is smaller than 0.000001, see Table 1.

TABLE 1

| Date | ⁸⁷Sr/⁸⁶Sr | ⁹⁰Sr/⁸⁶Sr | ¹³⁸Ba/¹³³Cs | ¹³⁷Cs/¹³³Cs |
|---|---|---|---|---|
| 1913 | 0.710364 ± 85 | <0.000001 | 0.002327 ± 29 | <0.000001 |
| 1914 | 0.711202 ± 14 | <0.000001 | 0.000158 ± 56 | <0.000001 |
| 1927 | 0.708203 ± 74 | <0.000001 | 0.003065 ± 55 | <0.000001 |
| 1990 green | 0.713820 ± 24 | 0.000011 | 0.000972 ± 82 | 0.000139 |
| 1990 brown | 0.713995 ± 35 | 0.000024 | 0.001200 ± 74 | 0.000415 |
| 1987 | — | — | 0.024898 ± 58 | 0.001500 |

Looking at other isotopes, it is well-known that natural physical carbon has two stable isotopes, ¹²C and ¹³C. They fractionate in different processes including photosynthesis that leads to the concentrating of organic compounds of ¹²C compared to atmospheric carbon dioxide to which the parameter of δ¹³C comes to −0.7 ⁰/₀₀, see e.g. Monson, K. D., Hayes, J. M.: “Carbon isotopic fractionation in the biosynthesis of bacterial fatty acids”, Geochimica et Cosmochimica acta, 1982, Vol. 46. pp. 139-149, and Park, R., Epstein, S.: “Carbon isotope fractionation during photosynthesis”, Geochimica et Cosmochimica acta, Vol. 21, 1960, pp. 110-126. The quantity δ¹³C is defined as:

$${δ}^{13} C = [ \frac{( {}^{13} C / {}^{12} C ) inv - ( {}^{13} C / {}^{12} C ) stable}{{(}^{13} C / {}^{12} C ) stable} ] \times {10}^{3}$$

The parameter δ¹³C in living plants, where the process of photosynthesis is going on, varies within from −6 to −34 ⁰/₀₀. Besides, plants of the same type which grow in the same region can be characterized by the same parameter δ¹³C.

During the last 200 years, from the beginning of the industrial era, there has been a gradual change of the isotopic combination of atmospheric carbon dioxide from −7.0 ⁰/₀₀ to −7.8 ⁰/₀₀ that has directly influenced the isotopic composition of carbon in plants. Measurements of this isotopic combination in linseed oil used as binding substance in paint samples taken from paintings dated from 1811 to 2004 have been made and show that the value of δ¹³C changes from −19 ⁰/₀₀ to −29 ⁰/₀₀ during this period at about 200 years. Hence, this method can be used for determining the date when the examined paint was prepared and hence gives a reliable date of the corresponding paintings.

Mass-spectrometric measurements were made using the spectrometer model DELTA^{plus}XL, Termofinnegan.

Furthermore, in the natural environment, isotopes of plutonium (Pu) exist having mass numbers in the range of 238-242 that have different half-life periods: ²³⁸Pu 87.7 years, ²³⁹Pu 24 110 years, ²⁴⁰Pu 6 560 years, ²⁴¹Pu 14.1 years, ²⁴²Pu 373510 years. From 1964, after the crash of the American navigation satellite SNAP-9A that was supplied with an isotopic source of energy, there has been dispersed 629 TeraBq of ²³⁸Pu in the atmosphere of the earth. This event has caused the substantial changes of the relative concentrations (²³⁸Pu/²³⁹Pu) and (²³⁸Pu/²⁴⁰Pu) on a global basis. Hence, this fact can be used for dating different objects produced after 1964, including paintings.

The high-energy cosmic emission observable at the border of the atmosphere of the earth leads to the formation of the isotopes of some chemical elements such as ³H, ⁴⁴Ti, ³⁹Ar, ³²Si, ¹⁴C, ⁵⁹Ni, ³⁶Cl, ⁵³Mn, ⁶³Ni and ⁵⁷Co which reach the surface of the earth with the meteoric waters and join in the general circuit of substance. Some of them, for instance ³H, ¹⁴C, have already been used for dating of different natural and cultural objects. For dating of painting objects, ³²Si having a half-life period of 650 years, and ⁶³Ni having a half-life period of 125 years can be used.

While specific embodiments of the invention have been illustrated and described herein, it is realized that numerous other embodiments may be envisaged and that numerous additional advantages, modifications and changes will readily occur to those skilled in the art without departing from the spirit and scope of the invention. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention. Numerous other embodiments may be envisaged without departing from the spirit and scope of the invention.

1. A method of dating a painting comprising the steps of:
selecting an element participating in the general flow of substances between non-living matter and living plants, in particular plants used for making binding agents of artistic paint, such as flax,
selecting two isotopes of said element which participate in said flow,
determining the concentrations of said two isotopes in relation to each other, and
using the concentrations for dating the painting.

2. A method according to claim 1, wherein during the step of using the concentrations, a calibration is made including the steps of:
taking paint samples of paintings securely dated within a time period at least including the time when said painting is alleged to have been made,
determining the concentrations of said two isotopes in relation to each other in the paint samples, and
comparing the determined concentrations in said painting to the determined concentrations in the paint samples and therefrom estimating the date when the paint in said painting was prepared.

3. A method according to claim 1, wherein the two isotopes are selected so that one of them is radioactive, having a half-life period smaller than 1000 years, in particular a half-life period smaller than 200 years.

4. A method according to claim 1, wherein the two isotopes are selected so that one of them is radioactive and the other one is substantially stable.

5. A method according to claim 3, wherein the radioactive isotope is selected to have a half-life period adapted to or in the range of the length of the time period from the date or year when the painting is alleged or supposed to have been made to the date or year when the dating is made, in particular a half-life period larger than 25% of said time period and/or smaller than 400% of said time period.

6. A method according to claim 1, wherein the two isotopes are a pair among the following:
^{π}Sr and ^{ξ}Sr,
¹³⁷Cs and ¹³³Cs,
¹²C and ¹³C,
²³⁸Pu and ²³⁹Pu,
²³⁸Pu and ²⁴⁰Pu,
³²Si and ²⁸Si, and
⁶³Ni and ⁵⁸Ni.
